(19) United States
(12) Patent Application Publication
(10) Pub. No.: US 2018/0346296 A1
(43) Pub. Date: Dec. 6, 2018

(54) SYSTEM AND SPOOLING DEVICE FOR SPOOLING OF A ROPE ON A WINCH DRUM

(71) Applicant: ROLLS-ROYCE MARINE AS, HAREID (NO)

(72) Inventor: IVAR BJORNEVIK, EIDSNES (NO)

(21) Appl. No.: 15/779,130

(22) PCT Filed: Nov. 15, 2016
(86) PCT No.: PCT/NO2016/050229

§ 371 Date: May 25, 2018

(30) Foreign Application Priority Data
Nov. 25, 2015 (NO) 20151605

(51) Int. Cl. B66D 1/52; B66D 1/38

(52) U.S. Cl. CPC B66D 1/52; B66D 1/38

(57) ABSTRACT

A spooling apparatus (40) for spooling and regulating the pull of a rope (12) or a cable that shall be spooled onto or out from a winch drum (22), comprising a spooling sheave (42) onto which the rope (12) is guided before it is spooled onto the winch drum (22), where the spooling apparatus (40) comprises a linearly moving slide (44) and that the spooling sheave (42) is mounted in the slide (44) so that it can be tilted sideways. Also described is a system for the spooling in of a rope (12) or a cable that shall be spooled onto or out from a winch drum (22) comprising a winch (20) with said winch drum (22) and a traction unit (26) for the tension on the rope (12), and also a spooling apparatus (40).

### AREA OF THE INVENTION

The present invention relates to a spooling apparatus for spooling and possible regulation of the pulling tension in a rope or a cable that shall be spooled onto or out from a winch drum, comprising a spooling sheave which the rope is guided onto before it is spooled on to the winch drum.

The invention also relates to a system for spooling in of a rope or a cable that is to be spooled onto or out from a winch drum, comprising a winch with said winch drum, a traction unit and a spooling apparatus. The invention is intended to be used with fibre ropes, but can also be used with other types of rope, cables and similar elongated bodies, and is, in the main, intended for use in subsea lifting operations, interventions, pipe-laying operations, etc. However, the invention can also be used in other types of operations.

The invention is also intended to be used together with, for example, a crane structure, an A-frame, a moon pool tower or other structures used to bring a load to or from the deck and out from or into the water.

### BACKGROUND TO THE INVENTION

Spooling devices are used to spool a rope that is spooled onto or from a winch drum, and is particularly used on vessels within the oil and gas industry. The known devices comprise several rope sheaves or drums that can provide a pull on the rope, where the rope sheaves or drums can rotate in relation to each other or they can rotate together to regulate the tension in the rope that is to be spooled onto the winch drum. It is also known that it can be provided a braking effect onto the rope to regulate the pull on the rope before the rope enters the appliance.

One problem with the known devices is that the rope can be spooled onto the winch drum at a tension, or rope pull, that can be too low or too high, which can lead to a risk for the rope at a low tension or rope pull being spooled up too loosely and at a too high tension and rope pull will be forced into the loosely spooled layers of the rope underneath. This can lead to damage to the rope and disrupt the operation.

### DESCRIPTION OF PRIOR ART

US 2004/0069981 A1 (BOMBARDIER INC.) describe an appliance to spool a wire onto a drum, where the appliance is fitted with an arm that guides the wire to the right place on the drum.

US2015076266 A1 (DEEP TEK WICH IP LIMTED) relates to a drum and a method to place a line/rope onto the drum under the protection of an oscillating/swinging device to provide vibrations in the line that is spooled onto the drum. This leads to fluctuations in the tension in the line. The device also has a sideways directed movement for the guiding of the line.

U.S. Pat. No. 3,749,367 (INSTITUT FRANCAIS DU PETROLE) relates to an appliance to achieve, in the main, a constant tension in a flexible line that is used in drilling installations. This concerns movements/displacements in line-carrying sheaves. FIG. 5 shows a preferred embodiment of the invention.

NO20101636 A (HUSE EGINERING AS) relates to, among other thing, a device for a winch for the operation of a hoisting line to carry out heave compensation. In order, it comprises a traction winch, a tightening unit and a secondary winch for the line, said tightening arrangement makes up a buffer to hold the line between the traction winch and the secondary winch at an approximately constant tightening.

Furthermore, reference is given to JP1242396 A2 (KONISHi AKIO) and JP2004217422 A (NAGAO KOJI). JP1242396 A2 relates to a winch with a cable provider with two cable guiding sheaves that are mounted in an appliance that can swing and turn forwards and backwards about an axis perpendicular to the drum axis. It is not described whether this turning is driven by motor power or not. JP2004217422 A relates to a similar apparatus.

U.S. Pat. No. 6,983,927 B2 (MICHEL PELLETIER ET AL) relates to a winch fitted with a cable-carrying spooling appliance that swings with the help of an actuator that can be hydraulic or pneumatic. FR1330280A (Godderidge Jean) relates to a spooling appliance where the oscillating movement of rope-carrying sheaves is promoted by a rotating screw in engagement with a nut.

### OBJECTS OF THE PRESENT INVENTION

One disadvantage with the prior art is that there are no apparatuses with integrated functions for the spooling of the rope and dampening of variations in the rope pull, and also possible pulling ability.

It is an object of the invention to provide a spooling apparatus where the above mentioned functions can be integrated on one and the same apparatus.

Furthermore, it is an object to provide a spooling apparatus with possibilities of control of the speed of the rope in the spooling apparatus and onto the winch drum, and which can give an additional safety in emergency stops. In this way, a spooling apparatus can be provided which adjusts the tension in the wire and guides the wire onto the drum.

Furthermore, it is an object of the invention to provide an alternative to the known solutions that is readily compact and simple to use.

With this invention one can also obtain a reduction of the loads on the system due to the external load changes and uneven loading operations.

### SUMMARY OF THE INVENTION

Said objects are achieved with a spooling apparatus as given in the independent claim, in which it is given a spooling apparatus for spooling of a rope or a cable that shall be spooled onto or out from a winch drum, comprising a spooling sheave about which the rope is guided before it is spooled onto the winch drum, and where the spooling apparatus comprises a linearly moving slide, and that the spooling sheave is mounted sideways tiltable in the slide.

Alternative embodiments are given in respective dependent claims.

The spooling sheave can be sideways tiltable transvers to the linear movement direction of the slide.

The spooling sheave can be mounted in a sideways tiltable sheave support, where the sheave support is mounted in a central, longitudinally running bearing shaft in the slide.

The slide can comprise a drive cylinder to provide said tilting movement of the spooling sheave.

The spooling sheave can alternatively be tilted sideways in that the spooling sheave can be moved linearly in two directions in parallel with the winch drum. In this case, a flag sheave can be arranged to take up changes in the outlet position of the rope from the spooling apparatus. Alternatively, the slide can comprise a cogged wheel system or the like to provide said tilting movement of the spooling sheave.

The slide can be arranged to move linearly on a number of rods to provide dampening of the rope that is guided through the spooling apparatus, and where the slide comprises a number of cylinders to provide the linear dampening movement.

The cylinders for the provision of the linear dampening movement can be adjusted to hold a constant pressure in a given position.

Furthermore, the slide can be arranged to move linearly on a number of rods to provide the dampening of the rope that is guided through the spooling apparatus and the slide can comprise a cogged wheel system to provide the linear dampening movement.

Furthermore, the spooling sheave can be connected to one or more drive units to regulate the speed of the spooling sheave and thereby the load on the rope across the spooling sheave.

Said objects are also achieved with a system for spooling up of a rope or a cable that shall be spooled onto or out from a winch drum, comprising a winch with said winch drum, and a traction unit for the tension in the rope, in which a spooling apparatus is arranged between the winch drum and the traction unit, and where the spooling apparatus comprises a spooling sheave which is mounted so that it can tilt sideways in a linearly moving slide to guide the spooling in, and any pull on the rope, of the rope on the winch drum.

The spooling apparatus can be designed as given above, where the spooling apparatus is arranged to receive the rope from the traction unit.

The spooling apparatus, traction unit and the winch can be connected to a control system for the regulation of the respective units.

### DESCRIPTION OF THE FIGURES

Preferred embodiments of the invention shall, in the following, be described in more detail with reference to the enclosed figures, in which:

FIG. 1 shows an example of an assembly of a spooling apparatus according to the invention together with a crane, traction unit and a winch.

FIG. 2 shows in more detail the spooling apparatus according to the invention together with the winch and the traction unit.

FIG. 3 shows a slide with a spooling sheave that is part of the spooling apparatus according to the invention.

FIG. 4 shows correspondingly a slide with a spooling sheave that is part of the spooling apparatus according to the invention.

FIG. 5 shows means for the tilting movement of the spooling sheave in the slide shown in FIGS. 3 and 4.

FIG. 6 shows corresponding means for the tilting movement of the spooling sheave in the slide shown in FIGS. 3 and 4.

### DESCRIPTION OF PREFERRED EMBODIMENTS OF THE INVENTION

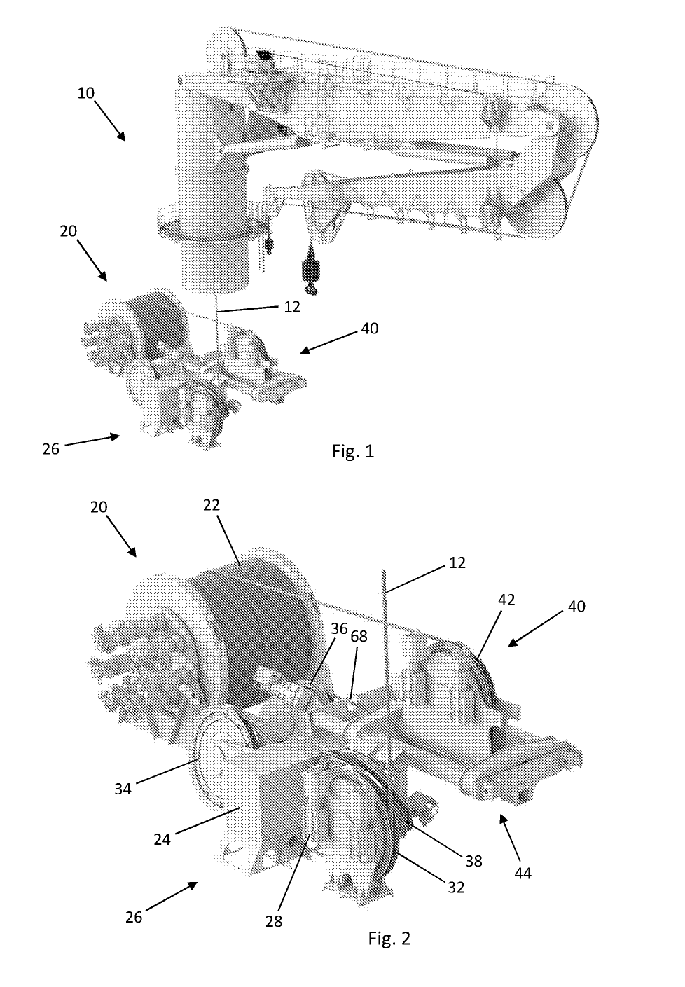

FIG. 1 shows an example of an embodiment of the invention together with a traction unit 26, a winch 20 and a crane 10. The crane 10 is a crane especially designed for fibre ropes, but the invention can, as previously mentioned, also be used together with other lifting devices. A rope 12 runs from the crane 10 and through the traction unit 26, further to a spooling apparatus 40 and to a winch drum 22 on the winch 20.

The spooling apparatus 40 is particularly suited for regulation of the tension in the rope 12 or a cable, or any other elongated body that shows the same characteristics and are hereinafter denoted as rope.

In FIG. 2, the spooling apparatus 40 according to the invention is shown together with the traction unit 26 and the winch 20. The spooling apparatus according to the invention can be used without the traction unit 26, where the rope 12 can be routed directly from the cargo.

It can be seen that the traction unit 26 comprises several rope sheaves 32, 34, 36, 38 around which the rope 12 runs. In more detail, in the embodiment example shown, the traction unit 26 is equipped with a first rope sheave 32 that receives the rope 12 from the crane 10, and also several intermediate and biased rope sheaves 34, 36, 38, that can be fitted with braking devices 28 to regulate the speed and tension/pull on the rope 12. The traction unit 26 normally has the function to regulate the tension/pull on the rope and to adjust the spooling in of the rope 12 onto the winch drum 22. From the traction unit 26, the rope 12 runs onto the spooling apparatus 40 according to the invention and thereafter onto the winch drum 22 of the winch 20. The traction unit 26 which is shown is known to a person skilled in the arts and is therefore not described in more detail.

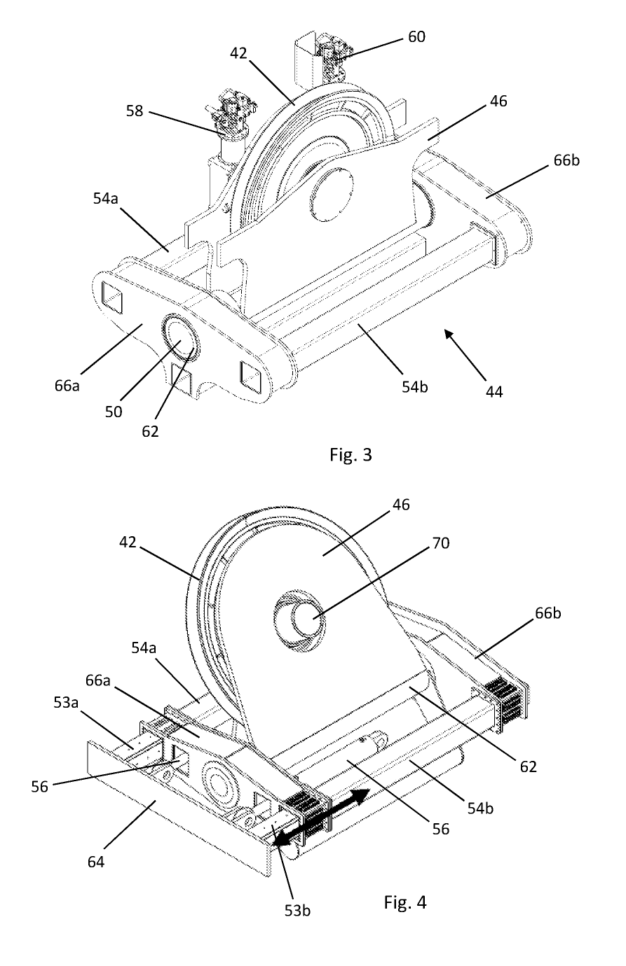

The FIGS. 3 and 4 show in more detail the spooling apparatus 40 according to the invention.

The spooling apparatus 40 can be fastened to a base 24 (shown in FIG. 2). The base 24 is initially made for the traction unit 26, but can also be the base for the spooling apparatus. Alternatively, a separate base can be used for the spooling apparatus.

The spooling apparatus 40 comprises in the embodiment shown a linearly moving slide 44 or a wagon. At least a forward part 64 of the spooling apparatus 40 is fixed to one of said bases or other foundation. From the forward part 64 of the spooling apparatus 40 runs a couple of rods 53a, 53b linearly in the longitudinal direction. Furthermore, the slide 44 of the spooling apparatus 40 comprises a first and a second slide part 66a,66b with intermediate, internally hollow profiles 54a,54b that surround the rods 53a,53b so that the slide can be moved linearly. For steering of the linear movement of the slide 44, the spooling apparatus 40 is preferably fitted with a pair of cylinders 56, preferably one on each side, but the displacement of the slide 44 can also be executed in other ways, for example, driven by a cogwheel or the like. Alternatively also by the use of mechanical springs, pneumatic dampeners or electrical springs. The cylinders 56 are fastened to the forward part 64 of the spooling apparatus 40 and are pressurised to drive the slide 44. The rope 12 that comes to the traction unit 26 runs through an opening 68 in the forward part 64 (shown in FIG. 2, not shown in FIG. 4) and in through an opening 50 in the first slide part 66a.

Furthermore, the spooling apparatus comprises a spooling sheave 42 that is normally placed in a sheave support 46. The spooling sheave 42 is fitted on a crosswise-shaft 70 in the sheave support 46, or alternatively suspended in, for example, a slewing ring. The rope 12 runs further around the spooling sheave 42 and onto the winch drum 22, as shown in FIG. 2. To adjust the pull on the rope 12 that runs around the spooling sheave 42, the sheave support 46 can be equipped with one or more drive units 58,60. By increasing or reducing the speed of the spooling sheave 42, the frictional force between the path of the spooling sheave 42 and the rope 12 is increased or reduced, and this influences the pull on the rope 12 before it runs onto the winch drum 22.

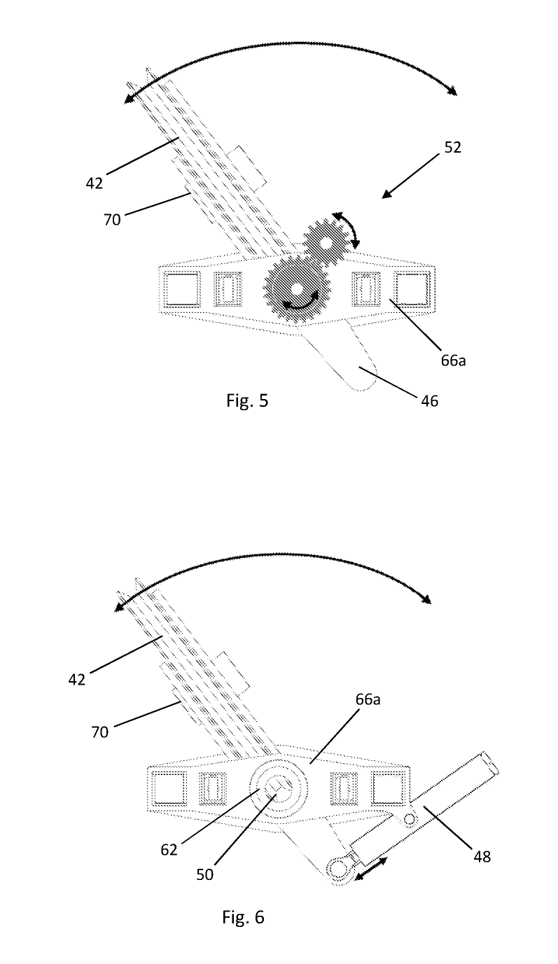

The spooling sheave 42, or preferably the sheave support 46 with the spooling sheave 42, is mounted in the slide 44 so that it can tilt sideways. The tilting movement is transvers to the longitudinal and linear movement of the slide 44, so that the sheave support 46 can rotate about its bearing point in a central, longitudinally running bearing shaft 62 in the slide 44. Thus, the path of the spooling sheave 42 has a sideways arch movement as shown by the arrows in FIGS. 5 and 6. The bearing point and the rope inlet 50 have preferably the same axis. FIG. 3 shows the spooling sheave 42 in an upright position, while FIGS. 4, 5 and 6 shows the spooling sheave tilted down to the one side. The spooling sheave 42 can naturally be tilted correspondingly to the other side.

Alternatively the spooling sheave 42 can be tilted sideways in that the spooling sheave 42 is arranged to be moved linearly in two directions, and where a flag sheave is arranged to take up changes in the outlet position of the rope from the spooling apparatus. Thereby, the spooling can be carried out with more than just rotation around a tilting point. The spooling can also be carried out in that the whole sheave 42 is displaced sideways to obtain spooling onto the winch drum, but the outlet will then not be fixed and a next sheave in the path should take care of such deviations. Other methods to do this can be with wire and a winch, direct operation, etc.

The FIGS. 5 and 6 show examples of how the tilting movement of the spooling sheave 42 can be brought about. FIG. 5 shows the use of a cogged wheel drive 52 and FIG. 6 shows the use of a pressurised cylinder 48.

The spooling apparatus 40, the traction unit 26 and the winch 20 can, on their own or together, be connected to a control system (not shown) for the steering of the respective units. The crane 10 can also be connected to the same control system.

### Tilt Spooling

Tilt spooling takes place in that the cylinder 48 (or the motor if there is a cogged wheel device) is steered to the desired position normal to the winch drum 22 to place the rope layers on the drum 22 as required. The control system places the spooling apparatus 40 in the right sideways position according to the path the spooling sheave 42 rotates round by the help of steering the position of the cylinder or motor.

### Dampening

Dampening takes place in that the cylinders 56 of the slide 44 are adjusted to hold a constant pressure at a given position of its stroke. A deviation from this position can be dealt with by the control system so that the winch 20 can increase or decrease the speed to get the slide 44 back to its desired position. The cylinders 56 of the slide 44 can also have a residual stroke to be able to handle different stopping times on the winch 20 and the traction unit 26.

### Traction

The spooling sheave 42 can, as mentioned, also be equipped with drive units 58,60 that result in the friction between sheave and rope being used to change the load over the sheave 42 from the inlet to the outlet.

In addition to the mentioned spooling apparatus, the invention also comprises a system for the spooling in of the rope 12 or the cable that shall be spooled onto or out from the winch drum 22, comprising the winch 20 with said winch drum 22, and the traction unit 26 for tensioning of the rope 12, and also the spooling apparatus 40 arranged between the winch drum 22 and the traction unit 26, where the spooling sheave 42 of the spooling apparatus 40 is mounted in the linearly moving slide 44 so that it can tilt sideways to guide the spooling in of the rope 12 onto the winch drum 22.

1. Spooling apparatus for spooling a rope or a cable that shall be spooled onto or out from a winch drum, comprising a spooling sheave onto which the rope is guided before it is spooled onto the winch drum,
wherein the spooling apparatus comprises a linearly moving slide, and that the spooling sheave is mounted sideways tiltable in the slide.

2. Spooling apparatus according to claim 1, wherein said spooling sheave is sideways tiltable transvers to the linear movement direction of the slide.

3. Spooling apparatus according to claim 2, wherein said spooling sheave is mounted in a sideways tiltable sheave support, where the sheave support is mounted in a central, longitudinally running, bearing shaft in the slide.

4. Spooling apparatus according to claim 2, wherein the slide comprises a drive cylinder arranged to impart said tilting movement of the spooling sheave.

5. Spooling apparatus according to claim 1, wherein said spooling sheave sideways tiltable in that the spooling sheave is arranged to be moved linearly in two directions in parallel with the winch drum.

6. Spooling apparatus according to claim 2, wherein the slide comprises a cogged wheel system arranged to provide said tilting movement of the spooling sheave.

7. Spooling apparatus according to claim 1, wherein the slide is arranged to move linearly on a number of rods to provide dampening of the rope that is led through the spooling apparatus, and that the slide comprises a number of cylinders arranged to provide the linear dampening movement.

8. Spooling apparatus according to claim 7, wherein said cylinder for the provision of the linear damping movement is arranged to be adjusted to hold a constant pressure in a given position.

9. Spooling apparatus (40) according to claim 1, wherein the slide is arranged to move linearly on a number of rods to provide dampening of the rope that is led through the spooling apparatus, and that the slide comprises a cogged wheel system arranged to provide the linear dampening movement.

10. Spooling apparatus according to claim 1, wherein the spooling sheave is connected to one or more drive units arranged to regulate the speed of the spooling sheave and thereby load on the rope across the spooling sheave.

11. System for spooling in a rope or a cable that shall be spooled onto or out from a winch drum, comprising a winch with said winch drum and a traction unit for tension on the rope,
wherein a spooling apparatus is arranged between the winch drum and the traction unit, and that the spooling apparatus comprises a spooling sheave that is mounted sideways tiltable in a linearly moving slide to guide the spooling in of the rope onto the winch drum.

12. System according to claim 11, wherein the spooling apparatus is configured according to claim 1.

13. System according to claim 11, wherein the spooling apparatus, the traction unit and the winch are connected to a control system for regulation of the respective units.

14. System according to claim 11, wherein the spooling apparatus is arranged to receive the rope from the traction unit.

15. Spooling apparatus according to claim 3, wherein the slide comprises a drive cylinder arranged to impart said tilting movement of the spooling sheave.

16. Spooling apparatus according to claim 3, wherein the slide comprises a cogged wheel system arranged to provide said tilting movement of the spooling sheave.
